(19) United States
(12) Patent Application Publication
(10) Pub. No.: US 2012/0054072 A1
(43) Pub. Date: Mar. 1, 2012

(54) AUTOMATIC CONTENT BOOK CREATION SYSTEM AND METHOD BASED ON A DATE RANGE

(75) Inventors: Kevin McCurdy, Hanover, NH (US); Dennis John, Meridian, ID (US)

(73) Assignee: PICABOO CORPORATION, Menlo Park, CA (US)

(21) Appl. No.: 12/872,400

(22) Filed: Aug. 31, 2010

(51) Int. Cl. G06F 17/00; G06F 3/048; G06Q 30/00

(52) U.S. Cl. 705/27.1; 715/235

(57) ABSTRACT

An automatic content book creation system and method are described in which the content is selected by date range.

### FIELD

The disclosure relates generally to a system and method for generating a photo book and in particular to a system and method for automatically generating a content book based on a date range.

### BACKGROUND

Systems and method that permit a user to organize a plurality of pieces of content are known. For example, the Picture Manager utility in Windows® allows a user to view a plurality of digital images, arrange the digital images and then view the plurality of digital images as a slide show. In addition, one can use Microsoft® Powerpoint® to generate and arrange a series of slides wherein each slide can contain one or more digital images so that a slideshow with the slides containing the digital images is generated. In addition, video editing system (both high end movie studio type systems and consumer systems) exist that allow a user to put together clips of video images into a movie or other video show.

However, no existing system is capable of using a date range to select content for a book, cluster the content and generate one or more page layouts for a book and it is to this end that the system and method are directed.

### BRIEF DESCRIPTION OF THE DRAWINGS

FIG. 1A is an example of an implementation of the photo story book system that incorporates the book generating capabilities;

FIG. 1B illustrates more details of the client computing device of the photo story book system;

FIG. 2 illustrates a method for generating a book based on a date range;

FIGS. 3A and 3B are examples of the user interface that allows the user to select a data range for the content to be included in a book; and

FIG. 4 is an example of the user interface presenting the one or more page layouts for a book to the user.

### DETAILED DESCRIPTION OF ONE OR MORE EMBODIMENTS

The disclosure is particularly applicable to a web-based photo/image book generation system and method and it is in this context that the disclosure will be described. It will be appreciated, however, that the system and method has greater utility since it can be implemented using various different hardware and software different than those disclosed below and may be used as a independent system (not part of the web-based photo book system), as part of a different content system, as a desktop application that is connected to the Internet and a web site (such as the photo book system, or with other systems in which it is desirable to be able to select a date range and generates one or more pages of a book automatically. In addition, the content clustered and laid out in the book may be various types of content including text and the like. Now, an example of a photo book system and method that can utilize the date range automatic book generating system and method is described for illustration purposes.

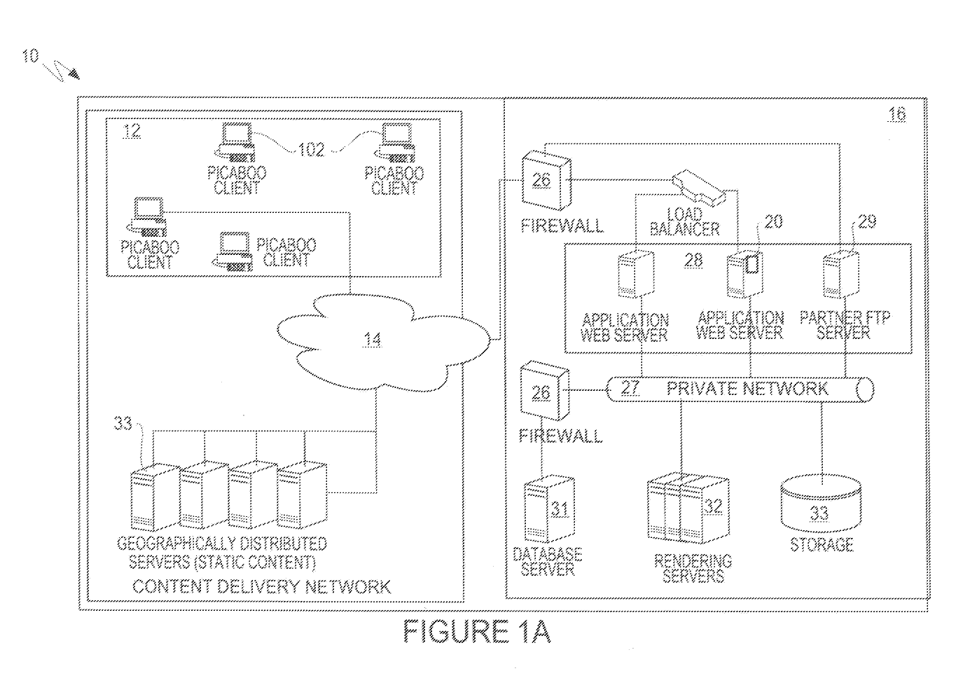

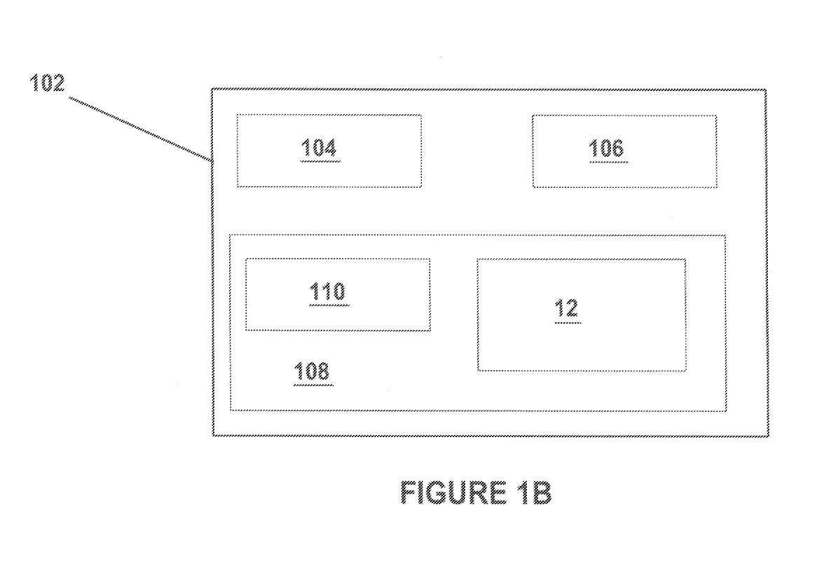

FIG. 1A is an example of an implementation of a web based photo story book system 10 that incorporates the data range automatic book generation capabilities. The web-based system, that may be a photo book system of Picaboo (www.picaboo.com) may include one or more computing devices 102 (such as the plurality of Picaboo clients as shown in FIG. 1) that may each be a processing unit based device with sufficient memory, display capabilities, storage space. processing power and connectivity (wired or wireless) to access and interact with a photo system 16 over a communications link 14 (wired or wireless). For example, each computing device may be a personal computer, laptop computer, desktop computer, a wireless device, a wireless email device, an integrated device such as a RIM Blackberry or Palm Treo device, a mobile phone or a cellular phone. The link 14 is in turn connected to a firewall device 26 that protects the internal network from malicious activities by having all data into and out from the internal systems pass through the firewall. The internal systems (that are behind the firewall) may include one or more application web servers 28 (one or more of which may execute the photo book system 20 that may be implemented in software in one embodiment) that receive requests and information from the computing devices and generate one or more web pages that contain information that can be displayed in a known browser application being executed by each computing device. The system may also include a known database server 31 that receives data requests, queries a storage unit 33 (that stores the various data and information associated with the photo book system) and delivers the requested data to the appropriate system element and one or more rendering servers 32 that renders the bound image albums that are produced by the photo system. The photo system 16 may be used to upload images and then generate a photo album based on the uploaded images of the user.

The main client application (that interacts with Picaboo unit 12 in FIG. 1) is the Picaboo application. The web application is this implementation may include the private proxies, account verification, file transfers, order pages and/or preview. The server application in the implementation may include album publishing, image extraction, data synchronization, rendering, user gateway, user registration and the session server.

Each Picaboo client 12 may be implemented as a hardware unit, as a combination of hardware and software (such as a computing device with a plurality of lines of code being executed by the processor of the computing device) or a software which has a plurality of lines of code being executed by the processor of a computing device of the user who is executing the Picaboo client. The Picaboo client allows the user to interact with the photo book system. For example, the Picaboo client allows a user to layout one or more pieces of content so that a book, when completed, can be printed for the user.

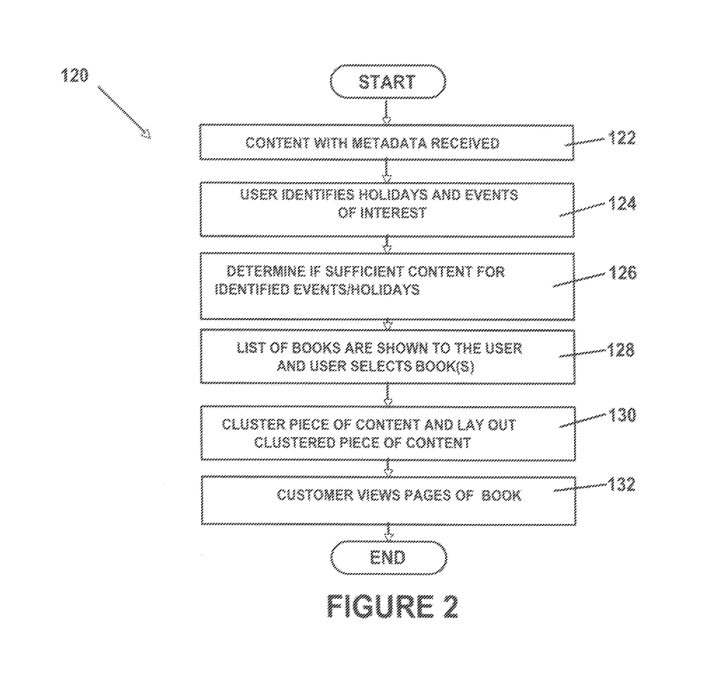

FIG. 1B illustrates more details of the computing device 102 of the photo story book system that includes the client 12. Each computing device 102 may include one or more processing units 104, one or more storage devices 106 (that may be various types of electronic/optical/magnetic, etc. storage devices and a memory 108 from which applications may be read into and then executed by the one or more processing units. For example, the memory may have an operating system 110 that controls the overall operation and functioning of the computing device as is well known and the client application 12 that is a plurality of lines of computer code that can be executed by the one or more processing units of the computing device. The client application performs various functions and operations including interfacing with the photo system 16. The client application 12 also may have a plurality of lines of computer code that implement the date range automatic book generation method as described below. The lines of computer code that implement the date range automatic book generation method may be a page generating unit within the client application or it may be implemented as separate hardware and hardware/software. The content clustering unit may further comprise a plurality of components that implement the processes described below in FIG. 2, such as a layout component, a date range determining component and the like. Alternatively, the date range automatic book generation method may be performed on the photo system and then the results are delivered to the client application. In one implementation, the part of the client application that implements the date range automatic book generation method may be implemented as an Adobe® Air Application using the Flex 3.5 framework and the logic is written in the Actionscript 3.0 language and uses XML for all storage and data structures. The computing device/client application also may store a plurality of pieces of content of the user of the computing device wherein the plurality of pieces of content of the user each have metadata associated with them.

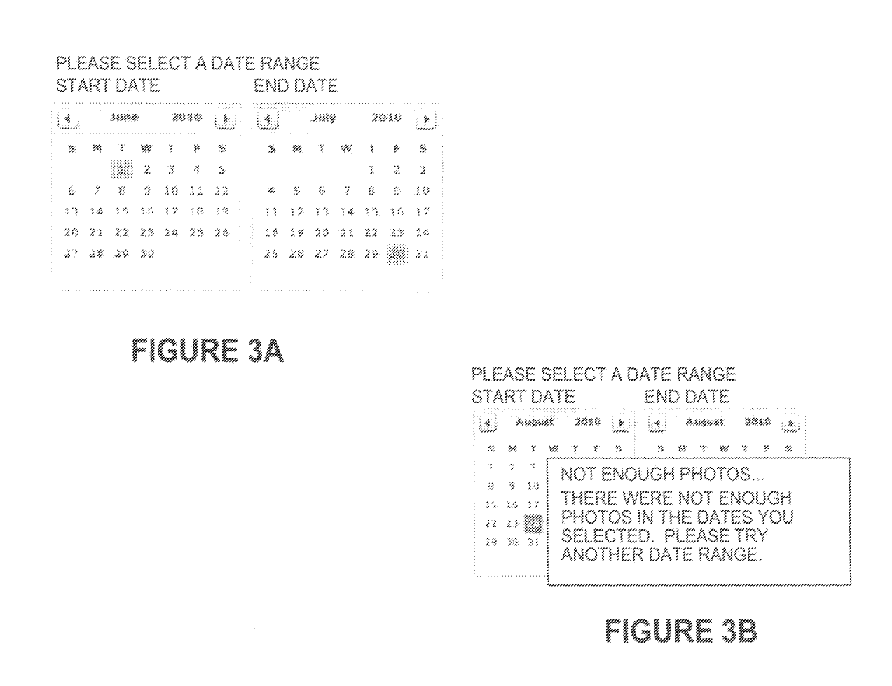

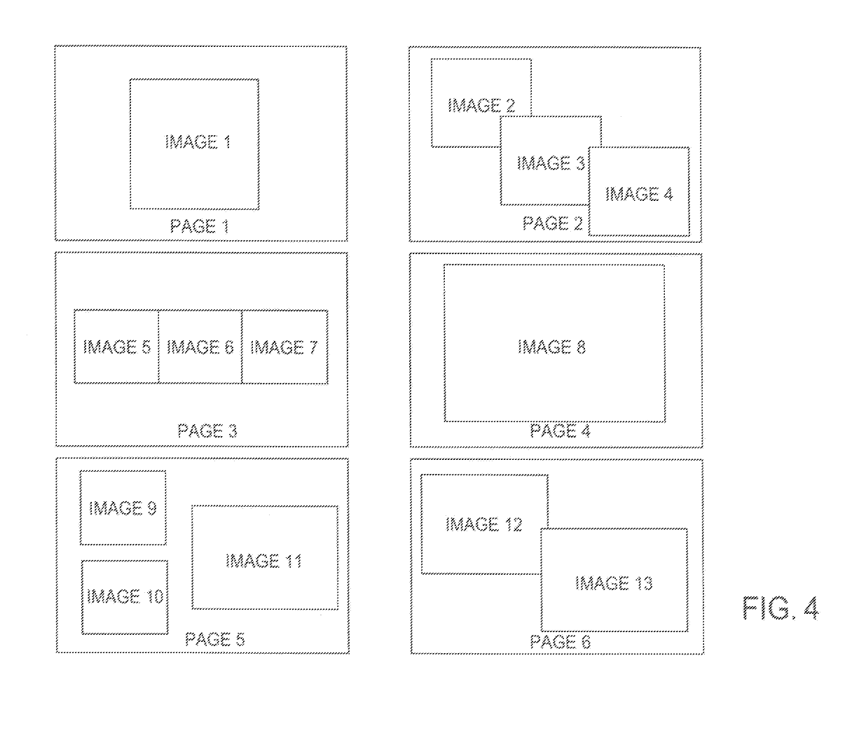

FIG. 2 illustrates a method 120 for generating a book based on a date range that may be implemented by the client application described above although it can also be implemented using other hardware/software. In the implementation in which the client application is performing the method, the client application has components that perform the processes described below. In the method, content with metadata is received/available for processing (122). In one embodiment use the illustration, the content may be pictures/images. In other embodiments, the content may be text, line drawings, cartoons and the like. The metadata for each piece of content may include for example, a photo/image name and a date/time that the photo/image is taken. To start the process to automatically generate a book (with one or more images/pictures on one or more pages in the example), the user may select a date range (124) from which pictures/images are used. FIG. 3A illustrates an example of a user interface that allows the user to select a date range. In the method, once a date range is selected, the method determines if the date range selected contains sufficient photo/images to fill a book with a predetermined number of pages (126). The minimum number of pages of a book may be configurable and may be, for example, 20 pages or 30 pages. For a target of a 20 page photo book, the minimum number of images is 30 which is currently what the application looks for. If the system were using a 30 page book, the system would use 50 as the minimum number of images. If the date range selected by the user does not contain sufficient photos/images, then the user is presented with a user interface (an example of which is shown in FIG. 3B) which permits the user to change/broaden the date range. Once the date range selected by the user contains a sufficient number of photos/images to fill the pages of a book, the method clusters the images/photos and lays out the pages of the book (128). An example of the technique for performing the clustering and page layout is described in co-pending patent application serial number entitled “Image Clustering and Page Layout System and Method” that was filed on the same day as this application, the entirety of which is incorporated herein by reference. Once the pages are laid out, the customer can view the laid out pages (130). An example of the user interface of the laid out pages in shown in FIG. 4. At this point, the customer can purchase the book using the system described above.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system for automatically generating a book of content, the system comprising:
a page generating unit that receives a set of content and generates one or more pages of a book containing a portion of the set of content, the page generating unit further comprising:
a component that receives a set of content wherein each piece of content has one or more pieces of metadata associated with the piece of content wherein the metadata includes a date of creation of the piece of content, a user component that allows a user to select a date range, a determining component that determines, based on the selected date range, if a sufficient number of pieces of content are within the date range based on the date of creation metadata and a lay out component that lays out one or more pages of a book based on the number of pieces of content are within the date range based on the date of creation metadata. a display, coupled to the page generating unit, that displays the one or more pages of the content with the content.

2. The system of claim 1, wherein the user component requests a different date range if the selected date range does not contain a sufficient number of pieces of content.

3. The system of claim 1 further comprising a book system for purchasing the book after the laid out pages of the book are viewed by the user.

4. The system of claim 1 further comprising a computing device used by a user wherein the computing device has one or more processing units and a memory associated with the one or more processing units and wherein the page generating unit further comprises a plurality of lines of computer code resident in the memory and executed by the one or more processing units.

5. The system of claim 4, wherein each computing device further comprises one of a personal computer, a laptop computer, a desktop computer, a wireless device, a wireless email device, an integrated device, a mobile phone and a cellular phone.

6. The system of claim 1, wherein the page generating unit further comprises a clustering component that clusters the pieces of content that are within the date range to generate one or more clusters that each contain at least piece of content and wherein the lay out component further comprises a lay out component that lays out the one or more pages of a book based on the number of pieces of content are within the date range based on the date of creation metadata and the one or more clusters.

7. The system of claim 1, wherein the identifier and generating unit further comprises a store that stores the set of content of the user.

8. A method for automatically generating a book of content, comprising:
receiving a set of content, each piece of content having one or more pieces of metadata associated with the piece of content wherein the metadata includes a date of creation of the piece of content;
selecting a date range;
determining, based on the selected date range, if a sufficient number of pieces of content are within the date range based on the date of creation metadata; and
laying out one or more pages of a book based on the number of pieces of content are within the date range based on the date of creation metadata.

9. The method of claim 8, wherein determining if a sufficient number of pieces of content are within the date range further comprises requesting a different date range if the selected date range does not contain a sufficient number of pieces of content.

10. The method of claim 8 further comprising presenting the laid out pages of the book to the user.

11. The method of claim 8 further comprising purchasing the book after the laid out pages of the book are viewed by the user.

12. The method of claim 8, wherein the laying out the pages further comprises clustering the pieces of content that are within the date range to generate one or more clusters that each contain at least pieces of content and laying out one or more pages of a book based on the number of pieces of content are within the date range based on the date of creation metadata and the one or more clusters.
